(19) United States
(12) Patent Application Publication
(10) Pub. No.: US 2016/0221070 A1
(43) Pub. Date: Aug. 4, 2016

(54) ROTATING MOLDING WITH INTEGRATED MIRROR WELDING

(71) Applicant: JP GROSFILLEY, MARTIGNAT (FR)

(72) Inventor: Philippe GAUDIN, GROISSIAT (FR)

(21) Appl. No.: 14/920,219

(22) Filed: Dec. 30, 2015

(30) Foreign Application Priority Data
Oct. 22, 2014 (FR) 1460165

(51) Int. Cl. B22C 9/06; B23K 31/02; B22D 29/00; B22D 17/00; B22D 17/22

(52) U.S. Cl. CPC B22C 9/065; B22D 17/002; B22D 17/2218; B22D 17/2236; B22D 29/00; B23K 31/02

(57) ABSTRACT

Injection mold for manufacturing a piece, the mold including: at least one first mold body, at least one second mold body, first and second mold bodies being positioned facing each other, at least one first platen having at least partially at least one molding cavity intended for forming a half-piece of piece, the first platen being positioned between the first and the second mold bodies, at least one second platen having at least partially at least one molding cavity intended for forming a complementary half-piece of piece, second platen being positioned between first platen and the second mold body, the first platen being mounted at least in rotation on first mold body so as to move in at least one position in which the molding cavity first platen is positioned facing molding cavity of second platen, characterized in that the injection mold includes at least one movably mounted heating member.

The invention concerns the field of molds for injecting preferably hollow pieces, in particular the pieces made of two portions or half-pieces sealingly joined to each other.

Said half-pieces may be joined from outside by an over-molded seal whose over-molding may be carried out in the injection mold in an integrated manner to the injection method as described in the French Patent FR 2 794 679 B1. The drawback of this type of junction lies in the fact that the partitions within the hollow volume are not secured, so that there is a risk of leakage and that the formed piece is of lower mechanical strength. Furthermore, the injection of a seal often requires the addition of an additional injection unit on the injection machine as well as the routing of the material by hot channels in the mold.

The half-pieces may also be joined from inside by mirror welding equipment. In this case, it is necessary to remove the half-pieces from of the injection mold and to assemble them on another station using a heating blade as a welding means. The drawback of this type of junction lies in the fact that this operation increases the costs to the extent that a station is completely created and dedicated to the welding after molding and that it requires hand labour at this station.

The invention aims to overcome all or piece of the aforementioned drawbacks.

The object of the invention is an injection mold for manufacturing a piece, the mold comprising:
at least one first mold body,
at least one second mold body, the first and the second mold bodies being positioned facing each other,
at least one first platen having at least partially at least one molding cavity intended for forming a half-piece of piece, the first platen being positioned between the first and the second mold bodies,
at least one second platen having at least partially at least one molding cavity intended for forming a complementary half-piece of piece, the second platen being positioned between the first platen and the second mold body,

said first platen being mounted at least in rotation on the first mold body so as to move in at least one position in which the molding cavity of said first platen is positioned facing the molding cavity of the second platen, characterized in that the injection mold comprises at least one movably mounted heating member, said heating member being configured to be positioned between the molding cavity of the first platen and the molding cavity of the second platen when said molding cavities are arranged facing each other.

Thus, the injection mold according to the invention integrates the welding functionality from inside and outside, which allows maintaining a high production rate while ensuring a sealed and reliable connection of the two half-pieces formed in the molding cavities of the mold.

In the present invention, the term [symbol] mold body [symbol] means the frame portions of the mold which may be movable or stationary.

In the present invention, the term [symbol] platen [symbol] means any support which may comprise at least partially one or more molding cavity(s).

According to one feature of the invention, the heating member is mounted in rotation and/or in translation on the first mold body or on the second mold body.

Preferably, the heating member is a heating blade.

According to one feature of the invention, the injection mold comprises at least one first injection station in which the molding cavity of the first platen is filled to form a half-piece of a piece, at least one second injection station in which the molding cavity of the second platen is filled to form a complementary half-piece, at least one welding station in which the molding cavity of the first platen is positioned facing the molding cavity of the second platen, the heating member being positioned at the welding station.

According to one feature of the invention, the passage from the second injection station to the welding station for the second platen is performed by the transfer of the half-pieces or by the rotation of the second platen.

Preferably, the second platen is mounted at least in rotation on the first mold body and/or on the second mold body.

According to one feature of the invention, the first platen is mounted in translation and in rotation on the first mold body.

According to one feature of the invention, the second platen is mounted in translation and in rotation on the first mold body, the second platen being positioned between the first platen and the second mold body.

According to one feature of the invention, the injection mold comprises material suppliers provided to feed a first molding cavity formed by the molding cavity of the first platen and/or the second platen.

According to one feature of the invention, said injection mold comprises at least one ejection station of pieces formed from the molding cavities of the first and the second platens.

According to one feature of the invention, said injection mold comprises at least one station for placing an insert.

According to one feature of the invention, the mold may comprise at least one material supplier configured to form a connection cord between the half-pieces.

Advantageously, the achievement of the connection cord is described in the document FR2794679 B1, particularly on page 3 lines 17 to 29, on page 4 lines 18 to 29, on page 5 line 30-31, page 8 lines 1 to 23, page 9 lines 19 to 35 and page 10 lines 5 to 20. Particularly, the mold may be equipped with material supplier so as to inject said connection cord at the time when the half-pieces are facing each other, and in particular after the assembling by contact by the heating member.

Advantageously, the connection cord may comprise additional functions of the assembly such as a fastening lug or other function, simplifying thereby the design of the mold.

The object of the invention is also a method for manufacturing a piece with an injection mold according to the invention, the manufacturing method including at least one manufacturing cycle comprising the following steps:
Injection of a half-piece into the molding cavity of the first platen within a first injection station,
Injection of a complementary half-piece into the molding cavity of the second platen within a second injection station,
Rotation of the first platen to the welding station,
Rotation of the second platen or transfer of the half-piece at the welding station,
Positioning of the heating member between the half-pieces of the first platen and the second platen,
Heating of the half-pieces,
Removal of the heating member,
Translation of the first platen and/or the second platen for the assembling of the heated half-pieces,
Assembling by contact of the previously heated half-pieces so as to form a piece,
Ejection of the formed piece.

According to one feature of the invention, the injection steps are carried out simultaneously.

According to one feature of the invention, the steps of rotation or transfer to the welding station are carried out simultaneously.

According to one feature of the invention, the manufacturing cycle comprises an additional step carried out before the rotation of the first platen to the welding station and/or before the rotation of the second platen to the welding station, the additional step consisting of the rotation of the first platen or the second platen to a station for placing an insert and placing of an insert in the half-piece of the platen having performed the rotation to said station for placing an insert.

According to one feature of the invention, said manufacturing method comprises several manufacturing cycles carried out simultaneously. Thus, the manufacturing efficiency is optimized.

According to one feature of the invention, said method comprises an additional step of injecting an outer connection cord to the two half-pieces. Preferably, the injection step of the cord is carried out before ejection of the assembled piece and after assembling by contact of the half-pieces.

The invention will be better understood thanks to the description hereinafter, which refers to several embodiments according to the present invention, given by way of non-limiting examples and explained with reference to the appended schematic drawings, wherein:

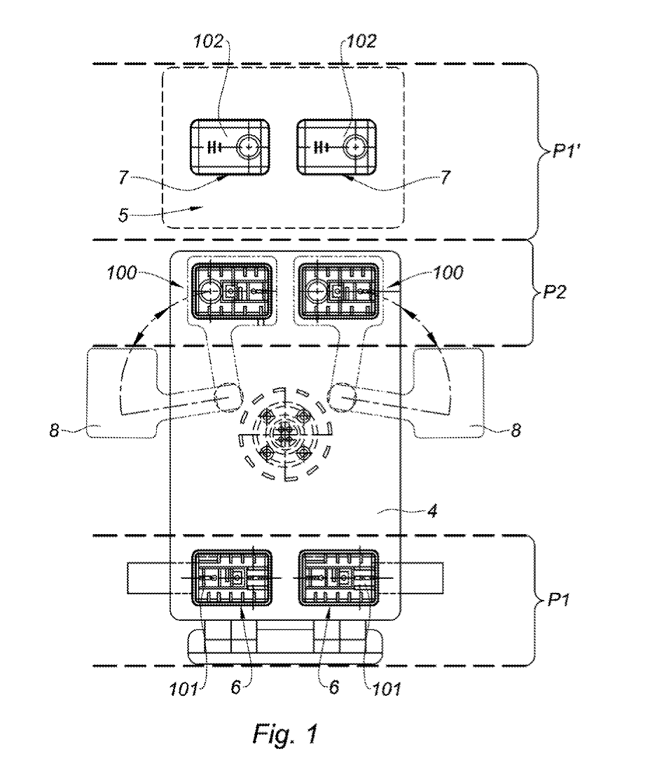

FIG. 1 is a partial schematic top view of the injection mold according to a first embodiment of the invention,

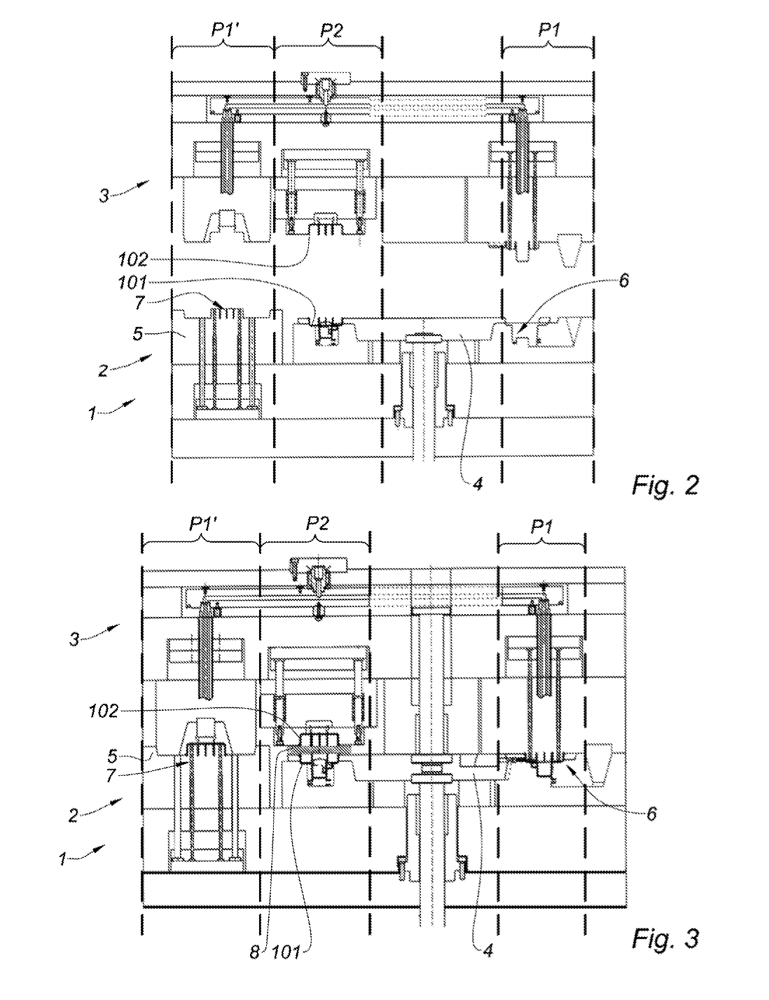

FIG. 2 is a partial schematic cross-sectional view of the injection mold shown in FIG. 1, during the positioning of the half-pieces to be assembled and welded,

FIG. 3 is a partial schematic cross-sectional view of the mold shown in FIG. 2, during the heating of the areas to be assembled on the half-pieces,

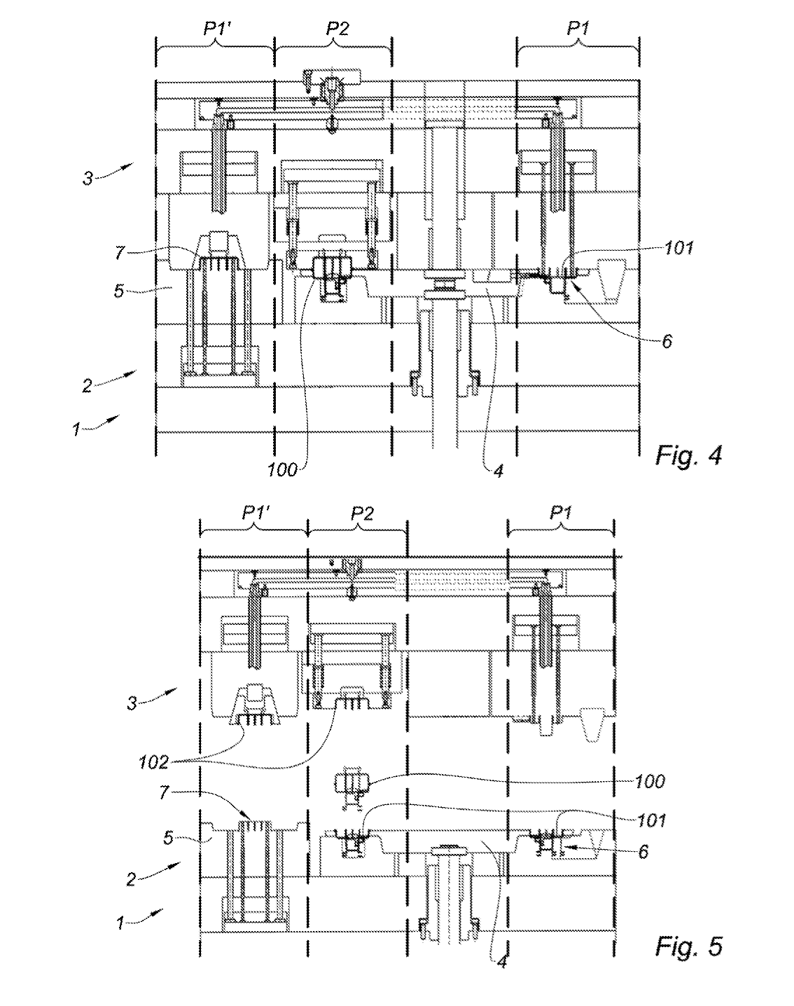

FIG. 4 is a partial schematic cross-sectional view of the mold shown in FIG. 2, during the assembling of the half-pieces,

FIG. 5 is a partial schematic cross-sectional view of the mold shown in FIG. 2, during the ejection of the piece,

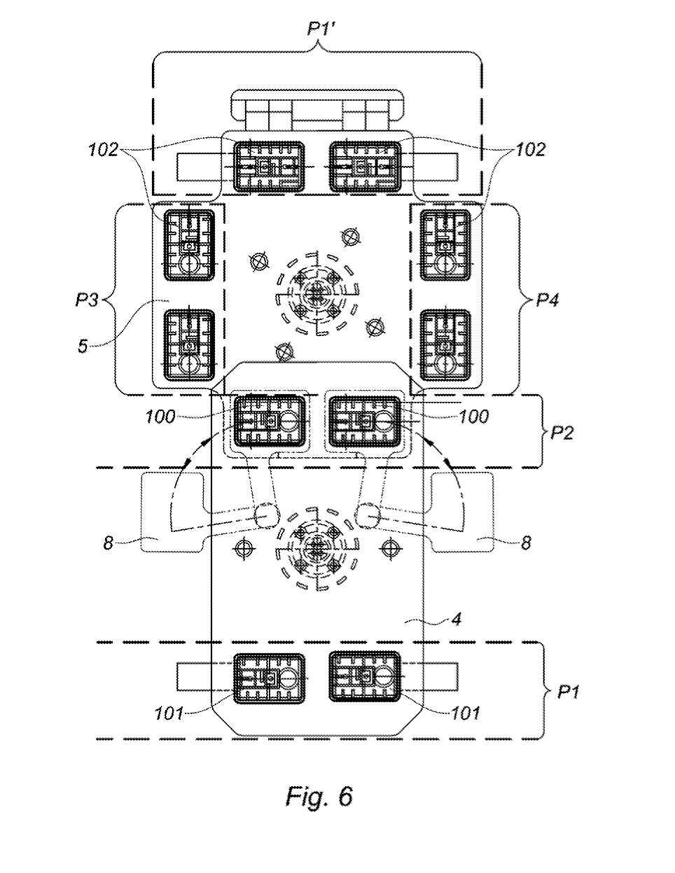

FIG. 6 is a partial schematic top view of the injection mold according to a second embodiment of the invention,

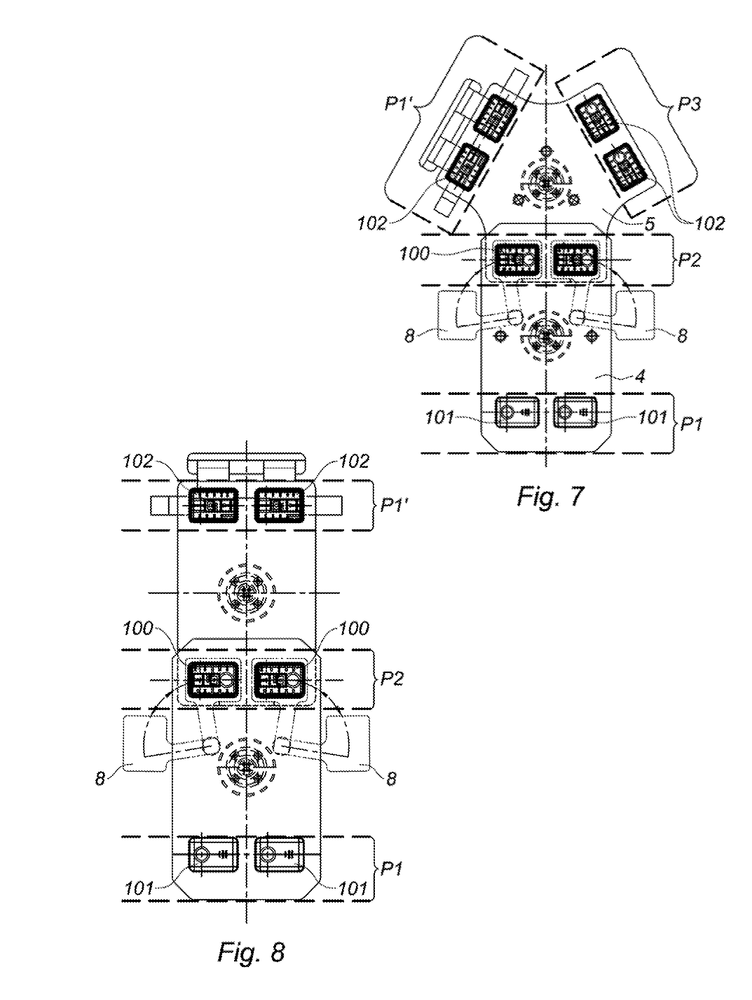

FIG. 7 is a partial schematic top view of the injection mold according to a third embodiment of the invention,

FIG. 8 is a partial schematic top view of the injection mold according to a variant of the first embodiment shown in FIG. 1,

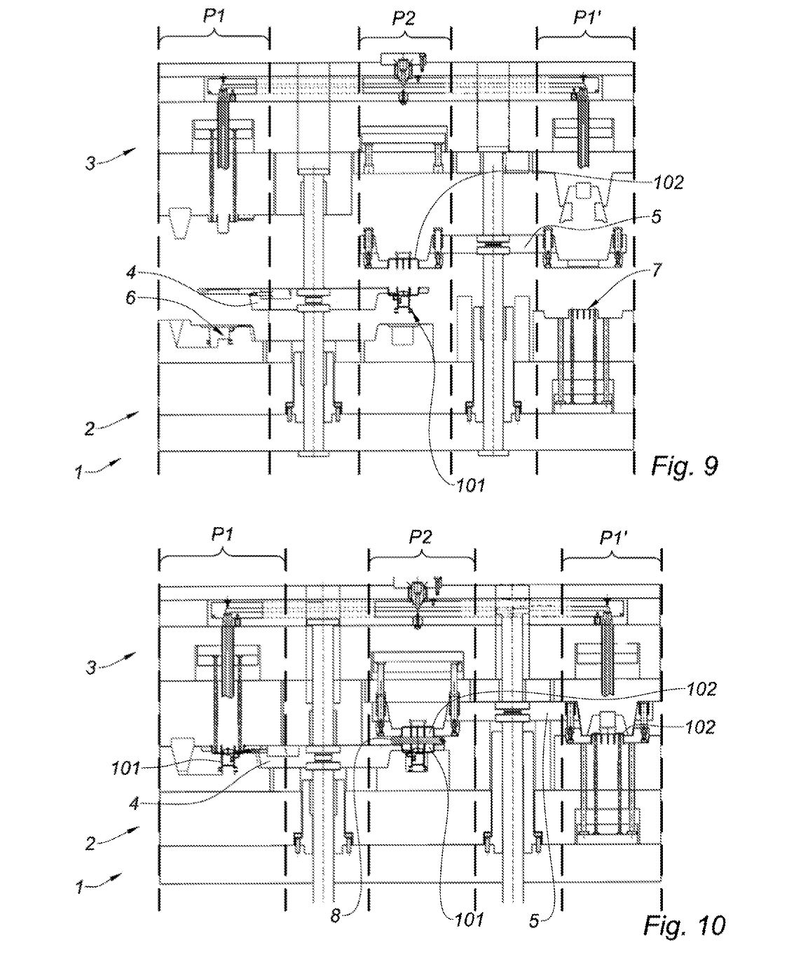

FIG. 9 is a partial schematic cross-sectional view of the injection mold shown in FIG. 8 during the positioning of the half-pieces to be assembled and welded,

FIG. 10 is a partial schematic cross-sectional view of the injection mold shown in FIG. 8 during the heating of the areas to be assembled on the half-pieces,

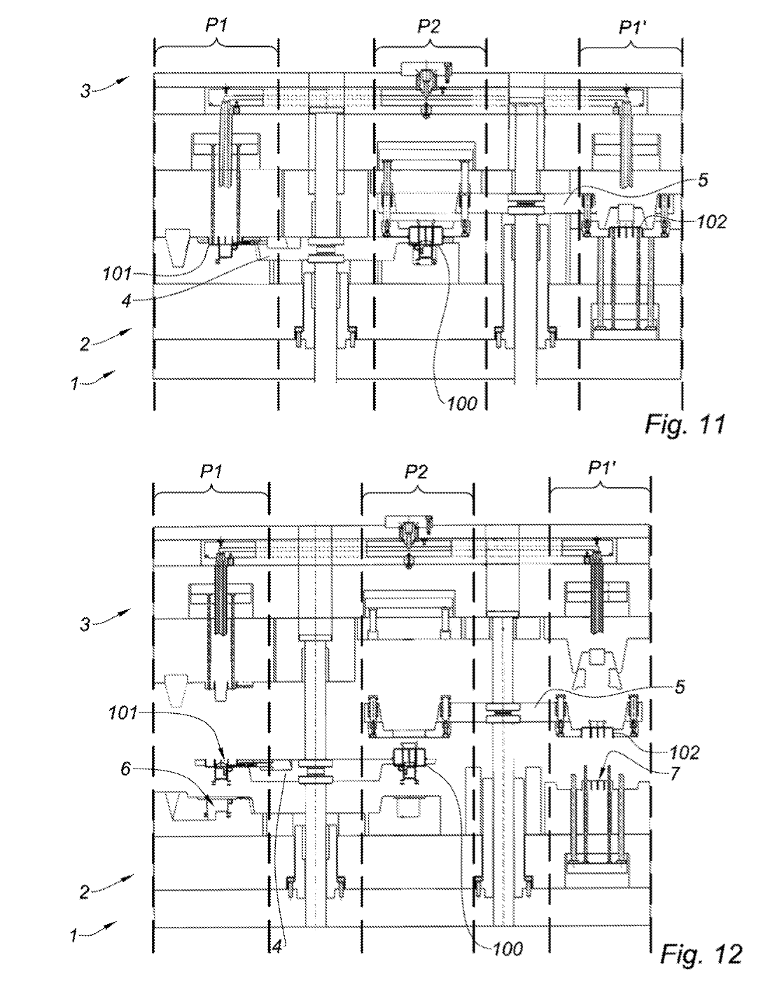

FIG. 11 is a partial schematic cross-sectional view of the mold shown in FIG. 8, during the assembly of the half-pieces,

FIG. 12 is a partial schematic cross-sectional view of the injection mold shown in FIG. 8 before the rotation of the open mold platens,

FIG. 13 is a partial schematic cross-sectional view of the injection mold shown in FIG. 5 during the placing of an insert and at the ejection phase of a closed mold piece,

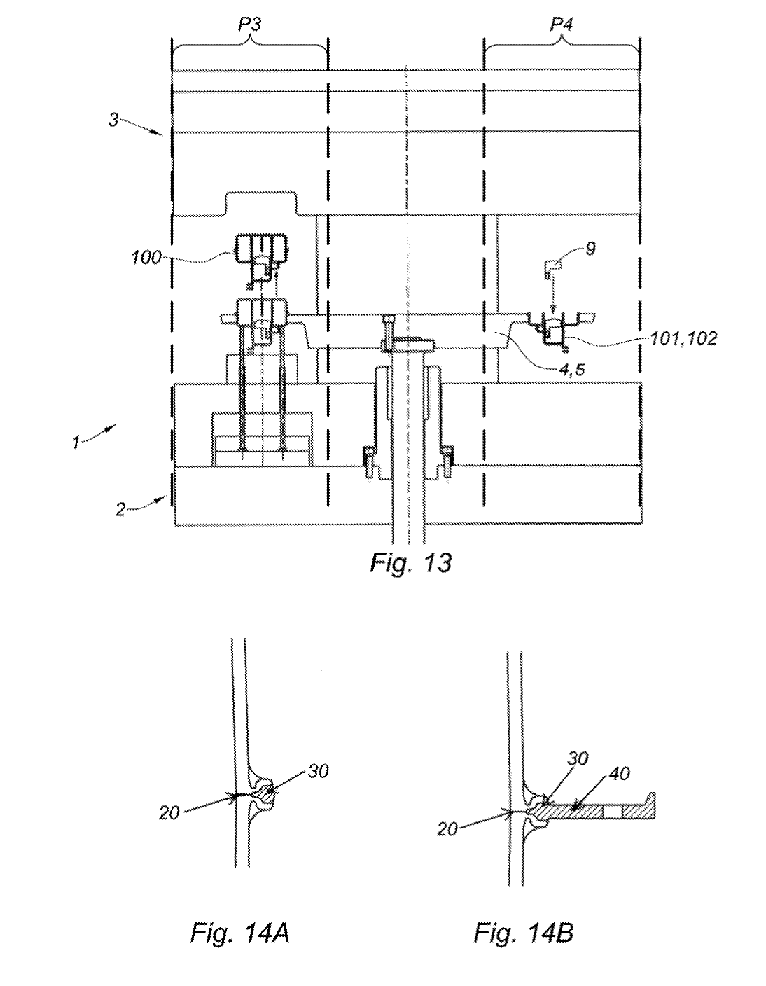

FIG. 14A illustrates a detail view of the injected piece comprising an outer connection cord,

FIG. 14B illustrates a detail view of the injected piece shown in FIG. 14A according to one variant.

The injection mold 1 according to the invention and regardless of the embodiment comprises a first mold body 2 and a second mold body 3 positioned facing each other. When the injection mold 1 is closed, the first mold body 2 is sealingly positioned against the second mold body 2 in order to carry out the molding of the pieces.

The injection mold 1 further comprises a first platen 4 and a second platen 5. The first platen 4 is mounted on the first mold body 2 in rotation and in translation. The second platen 5 is positioned between the first platen 4 and the second mold body 3. The second platen 5 is stationary according to the first embodiment, as illustrated in FIG. 1, while in the second, the third and the fourth embodiments of the injection mold 1, the second platen 5 is mounted in rotation and in translation on the first mold body 2, as illustrated in FIGS. 6 to 8.

According to any one of the embodiments of the injection mold 1, said injection mold 1 comprises two heating members 8 illustrated in FIGS. 1, 6, 7, 8. The heating members 8 are in the form of heating plates pivotally mounted on one of the mold bodies 2, 3.

Furthermore, the first platen 4 comprises a plurality of molding cavities 6 shaped for carrying out the half-pieces 101 of piece 100, said molding cavities 6 being partially arranged on the first mold body 2.

In addition, the second platen 5 comprises a plurality of molding cavities 7 shaped for carrying out the complementary half-pieces 102 of piece 100, said molding cavities 7 being partially arranged on the first mold body 2.

FIGS. 1 to 5 illustrate an injection mold according to a first embodiment wherein the first platen 4 is mounted in rotation on the first mold body 2 and the second platen 5 is stationary. In the first embodiment, the injection mold 1 comprises two injection stations P1, P1′ and a welding station P2. Each injection station P1, P1′ corresponds to the injection of a half-piece 101, 102 of piece 100 to be assembled and welded in the welding station P2.

FIGS. 2 to 5 partially illustrate a molding cycle according to the invention with an injection mold 1 according to the first embodiment.

More particularly, prior to the step illustrated in FIG. 2, an injection step of a half-piece 101 on the first platen 4 and a half-piece 102 on the second platen 5 has been carried out respectively at the injection stations P1, P1′.

Then, as illustrated in FIG. 2, the first platen 4 rotates and causes the half-piece 101 created at the injection station P1, to the welding station P2 and the complementary half-piece 102 made on the second platen 5 at the injection station P1′ is transferred to the welding station P2. The half-pieces 101, 102 are positioned facing each other.

Then, as illustrated in FIG. 3, the heating member 8 is pivoted and the half-pieces 101, 102 are advanced from one another until they are in contact or close enough to the heating member 8 to be heated. At the same time and as illustrated in FIG. 3, two other half-pieces 101, 102 are injected on the first and the second platens 4, 5.

Then, as illustrated in FIG. 4, the heating member 8 is removed, and the half-pieces 101, 102 are hot-assembled. In parallel, the injection continues in the injection stations P1, P1′.

Finally, the injection mold 1 is open, and the piece 100 made from the welded half-pieces 101, 102 is extracted, as illustrated in FIG. 5, the half-pieces formed during the welding of the piece 100 will now be assembled by repeating the steps previously described and illustrated in FIGS. 2 to 5.

In FIG. 8, an injection mold 1 is partially shown according to one variant of the first embodiment wherein the second platen 5 is mounted in rotation and in translation on the first mold body 2. In the variant of the first embodiment shown in FIG. 1, the injection mold 1 comprises two injection stations P1, P1′ and a welding station P2.

FIGS. 9 to 12 partially illustrate a molding cycle according to the invention with an injection mold according to the variant of the first embodiment.

More particularly, prior to the step illustrated in FIG. 9, an injection step of a half-piece 101 on the first platen 4 and a half-piece 102 on the second platen 5 has been carried out respectively at the injection stations P1, P1′.

Then, as illustrated in FIG. 9, the first and the second platens 4, 5 are rotated so that the injected half-pieces 101, 102 are facing each other at the welding station P2.

Then, as shown in FIG. 10, the heating member 8 is positioned between the half-pieces 101, 102 and the half-pieces 101, 102 are advanced from one another until they are in contact or close enough to the heating member 8 to be heated. At the same time and as illustrated in FIG. 10, two other half-pieces 101, 102 are injected on the first and the second platens 4, 5 at the injection stations P1, P1′.

Then, as illustrated in FIG. 11, the heating member 8 is removed, and the half-pieces 101, 102 are hot-assembled. In parallel, the injection continues in the injection stations P1, P1′.

Finally, the injection mold 1 is open, and the piece 100 made from the welded half-pieces 101, 102 is extracted, as illustrated in FIG. 12, the half-pieces formed during the welding of the piece 100 will now be assembled by resuming the steps previously described and illustrated in FIGS. 9 to 12.

The molding cycles which just have been described for a piece 100 can be made for several pieces 100 at the same time, depending on the configuration of the platens 4, 5 and the number of molding cavities 6, 7.

In FIG. 6, an injection mold 1 is partially shown according to a second embodiment. In the second embodiment, as mentioned previously, the second platen 5 is mounted in rotation and in translation on the first mold body 2.

In the second embodiment shown in FIG. 6, the mold comprises two injection stations P1, P1′, a welding station P2, an ejection station P3 of the made pieces 100, a station for placing an insert P4.

The molding cycle is substantially identical to those described with reference to FIGS. 2 to 5 and 9 to 12, additional steps are added for the additional stations.

According to the second embodiment, the injection mold 1 comprises an ejection station P3, thus, once the made piece 100, the second platen 5 on which the piece 100 lies is rotated to the ejection station P3 where the piece 100 is evacuated either manually or by transfer.

Furthermore, according to the second embodiment, the injection mold 1 comprises a station for placing an insert P4 in a half-piece 101, 102. This step is shown in FIG. 13. Before welding and assembling at the welding station P2, the second or the first platen 4, 5 is rotated to the insert placing station P4. Then the insert 9 in the half-piece 101, 102 is provided and said platen 4, 5 is pivoted to the welding station P2.

In FIG. 7, an injection mold 1 is partially shown according to a third embodiment. In the third embodiment, as mentioned previously, the second platen 5 is mounted in rotation and in translation on the first mold body 2.

Furthermore, in the third embodiment shown in FIG. 7, the mold comprises two injection stations P1, P1′, a welding station P2, and an ejection station P3 of the made pieces 100.

In one variant, not shown, of the third embodiment, the mold comprises two injection stations P1, P1′, a welding station P2, and an insert placing station P4 in the made half-pieces 100, the ejection being manual or mechanical and carried out at the welding station P2 once the half-pieces 101, 102 are assembled.

Regardless of the embodiment of the injection mold 1, the mold may comprise an additional supplier (not shown) of material to be injected configured to form an outer connection cord 30 at the inner welding connection 20.

The supplier is preferably positioned at the welding station P2 or on a dedicated station (not shown) positioned before the ejection station P3.

The thus formed piece has an inner welding connection 20 and an outer connection cord 30 as shown in FIG. 14A. Alternatively, the connection cord may comprise a fastening lug or other function 40 as illustrated in FIG. 14B.

Of course, the invention is not limited to the embodiments described and shown in the appended figures. Modifications remain possible, in particular from the point of view of the constitution of the various elements or by substitution of technical equivalents, without departing from the scope of protection of the invention.

1. An injection mold for manufacturing a piece, the mold comprising:
at least one first mold body,
at least one second mold body, the first and the second mold bodies being positioned facing each other,
at least one first platen having at least partially at least one molding cavity intended for forming a half-piece of piece, the first platen being positioned between the first and the second mold bodies,
at least one second platen having at least partially at least one molding cavity intended for forming a complementary half-piece of piece, the second platen being positioned between the first platen and the second mold body,
said first platen being mounted at least in rotation on the first mold body so as to move in at least one position in which the molding cavity of said first platen is positioned facing the molding cavity of the second platen, wherein the injection mold comprises at least one movably mounted heating member, said heating member being configured to be positioned between the molding cavity of the first platen and the molding cavity of the second platen when said molding cavities are arranged facing each other.

2. The injection mold according to claim 1, wherein the heating member is mounted in rotation and/or in translation on the first mold body or on the second mold body.

3. The injection mold according to claim 1, wherein the heating member is a heating blade.

4. The injection mold according to claim 1, wherein said injection mold comprises at least one first injection station in which the molding cavity of the first platen is filled to form a half-piece of piece, at least one second injection station in which the molding cavity of the second platen is filled to form a complementary half-piece, at least one welding station in which the molding cavity of the first platen is positioned facing the molding cavity of the second platen, the heating member being positioned at the welding station.

5. The injection mold according to claim 1, wherein the second platen is mounted at least in rotation on the first mold body and/or on the second mold body.

6. The injection mold according to claim 1, wherein said injection mold comprises at least one ejection station of pieces formed from the molding cavities of the first platen and the second platen.

7. The injection mold according to claim 6, wherein said injection mold comprises at least one station for placing an insert.

8. A method for manufacturing a piece with an injection mold according to claim 1, the manufacturing method including at least one manufacturing cycle comprising the following steps:
Injection of a half-piece into the molding cavity of the first platen within a first injection station,
Injection of a complementary half-piece into the molding cavity of the second platen within a second injection station,
Rotation of the first platen to the welding station,
Rotation of the second platen or transfer of the half-piece at the welding station,
Positioning of the heating member between the half-pieces of the first platen and the second platen,
Heating of the half-pieces,
Removal of the heating member,
Translation of the first platen and/or the second platen for the assembling of the heated half-pieces,
Assembling by contact of the previously heated half-pieces so as to form a piece,
Ejection of the formed piece.

9. The manufacturing method according to claim 8, wherein the manufacturing cycle comprises an additional step carried out before the rotation of the first platen to the welding station and/or before the rotation of the second platen to the welding station, the additional step consisting of the rotation of the first platen or the second platen to a station for placing an insert and placing an insert in the half-piece of the platen having carried out the rotation to said station for placing an insert.

10. The manufacturing method according to claim 8, wherein said manufacturing method comprises several manufacturing cycles carried out simultaneously.
